(19) United States
(12) Patent Application Publication
(10) Pub. No.: US 2008/0158358 A1
(43) Pub. Date: Jul. 3, 2008

(54) Transport means surveillance system

(75) Inventors: Daniel Chanson, La Chapelle Sur Erdre (FR); Dimitri Finker, New Haven, CT (US)

Correspondence Address: THELEN REID BROWN RAYSMAN & STEINER LLP, P. O. BOX 640640, SAN JOSE, CA, 95164-0640, US

(73) Assignee: TN INTERNATIONAL, MONTIGNY LE BRETONNEUX (FR)

(21) Appl. No.: 11/796,084

(22) Filed: Apr. 25, 2007

(30) Foreign Application Priority Data
Apr. 28, 2006 (FR) 06 51521

(51) Int. Cl. H04N 7/18

(52) U.S. Cl. 348/148; 348/E07.085

(57) ABSTRACT

Transport means surveillance system.

It comprises:
at least one camera (8) onboard the transport means (2);
a means of detecting movement (31) in the surrounds of the transport means;
an onboard server (14) that can hold images from the camera (8) and information from the means of detecting movement (31) close to the transport means;
a telecommunication means (18, 20) to transmit data provided by the server (14) to a surveillance centre (46);
a means (30) of detecting when the transport means stops,
the server switching the camera on or off and activating or deactivating the means of detecting movement close to the transport means as a function of information that it receives from the means (30) of detecting when the transport means is stopped.

### CROSS-REFERENCE TO RELATED PATENT APPLICATION OR PRIORITY CLAIM

This application claims the benefit of a French Patent Application No. 06-51521, filed on Apr. 28, 2006, in the French Intellectual Property Office, the disclosure of which is incorporated herein in its entirety by reference.

### FIELD OF THE INVENTION

The invention relates to a system for surveillance of a transport means onboard the transport means itself.

At the moment, the only way of surveillance of a transport means, for example a lorry or a railway wagon parked in a marshalling yard to assure detection of intrusion, is to provide security guards.

There are many disadvantages with providing human security guards for isolated wagons. Apart from the fact that it is expensive, it is only possible during long programmed shutdowns in preselected marshalling yards. It may also be relatively inefficient if the security guard has to travel long distances or if he does not have good visibility on the wagons for which surveillance is necessary.

A mobile surveillance vehicle is also known as described in US 2004/0123 328. It comprises a surveillance system designed to transmit images and to respond to orders received through the Internet. The system comprises at least one video camera and a video encoder coupled to the video camera. The video encoder is designed to encode an output signal from the camera in digital form. The system also comprises a video server coupled to the video encoder. The server is configured to format an output from the video encoder such that the video can be transmitted through the Internet. The surveillance system also comprises a communication module coupled to the video server. The communication module is configured to send the compressed video format as messages through Internet.

However, with a surveillance vehicle of this type, a remote operator needs to continuously monitor the transmitted images, which takes a great deal of time and is consequently expensive. Furthermore, this system operates continuously, such that it is not economic with batteries.

A video surveillance system onboard a vehicle such as a lorry is also known (WO 01/97524) comprising at least one video camera that generates video signals of an incident that occurs close to the vehicle, a recording device with coded access to store said video signals, a code to enable access to the recording device and means of downloading the video signals from the coded access recording device. However, this system also operates continuously such that its energy consumption is not optimised.

### PRESENTATION OF THE INVENTION

The purpose of this invention is a system for surveillance of a transport means that overcomes the disadvantages of currently known human security guards and video surveillance devices and enables automated surveillance, requiring only a small number of surveillance personnel. Finally, the system consumes only a small amount of electrical energy to extend its endurance.

These purposes are achieved according to the invention by providing the surveillance system with:
at least one camera onboard the transport means, the field of vision of this camera covering the entire surrounds of the transport means;
a means of detecting movement in the surrounds of the transport means;
an onboard server that can hold images of the camera and information from the means of detecting movement close to the transport means;
a telecommunication means to transmit data provided by the server to a surveillance centre at a distance from the transport means;
a means of detecting when the transport means stops,
the server switching the camera on or off and activating or deactivating the means of detecting movement close to the transport means as a function of information that it receives from the means of detecting when the transport means is stopped.

In a normal operating mode, the server switches the camera on and activates the means of detecting movement close to the transport means when it receives information from the means of detecting that the transport means is stopped, the server then transmitting data to the surveillance centre through the telecommunication means when movement has been detected in the surrounds of the transport means, the server switches the camera off and deactivates the means of detecting movement close to the transport means when it received information from the means of detecting that the transport means is stopped, informing it that the transport means has started moving.

In a hibernation mode, the server switches the camera off and deactivates the means of detecting movement close to the transport means, regardless of whether the transport means is moving or stopped.

In a forced operating mode, the server switches the camera on continuously, regardless of whether the transport means is moving or stopped, the server then transmitting data continuously to the surveillance centre through the telecommunication means.

The means of detecting movement close to the transport means is composed of either an infrared detector, or by the server processing images that it receives from the camera so as to detect a movement in its field of vision.

Advantageously, data transmitted by the telecommunication means include images close to the wagon.

In one preferred embodiment, data transmitted by the telecommunication means include data chosen from the group comprising the GPS coordinates of the wagon, the condition of the system power supply batteries, timestamping of images, a wagon identification number, a camera identification number, the state of the wagon (stopped or moving), the normal operating mode (system in hibernation or in forced operation) and sounds, in addition to images.

In particular embodiments, the movement detection means are composed either of a vibration detector, or a remote ultrasound detector.

Preferably, the means of detecting movement close to the transport means detect movement in the field of vision of the camera.

Preferably, the monitoring system comprises means of storing images taken by the camera.

Advantageously, the camera is capable of recording images from a brightness starting from 0.0003 lux.

Advantageously, the surveillance system comprises at least one infrared projector.

In one particular embodiment, the surveillance system comprises two cameras located at diagonally opposite corners of the wagon.

In another particular embodiment, the surveillance system comprises four cameras located at the four corners of the wagon.

Preferably, each camera comprises a head connected to a processor, this processor being a single processor for all cameras if there are several cameras, the processor being arranged in a box that contains the onboard server, so that nothing is outside the box except for the camera heads.

Other characteristics and advantages of the invention will become clearer after reading the description of example embodiments given below for illustrative purposes with reference to the appended figures. On these figures:

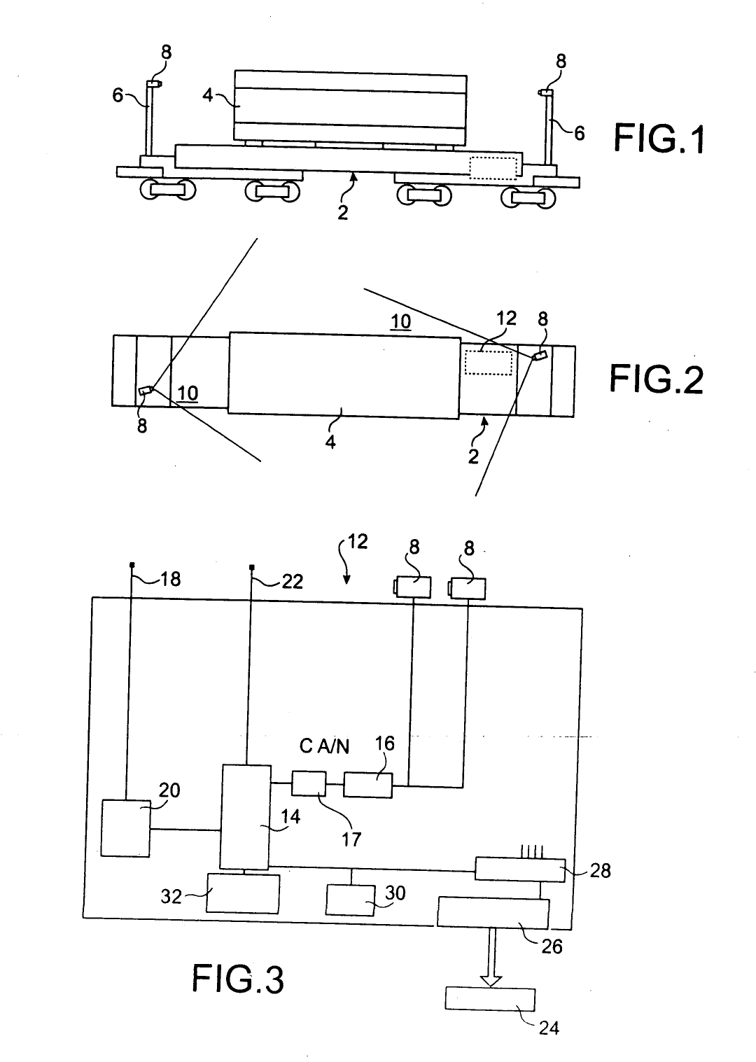

FIG. 1 shows an elevation view and FIG. 2 shows the top view of a wagon in which the system according to this invention is being used for surveillance;

FIG. 3 is a diagram of an electronic box forming part of a surveillance system according to this invention;

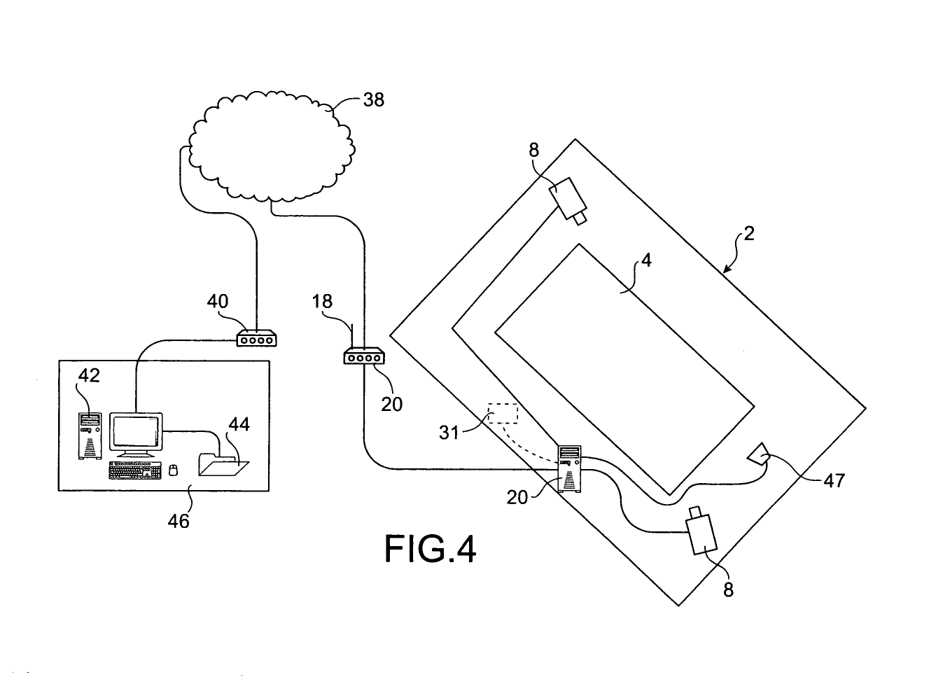

FIG. 4 is an overall diagram of the surveillance system according to the invention;

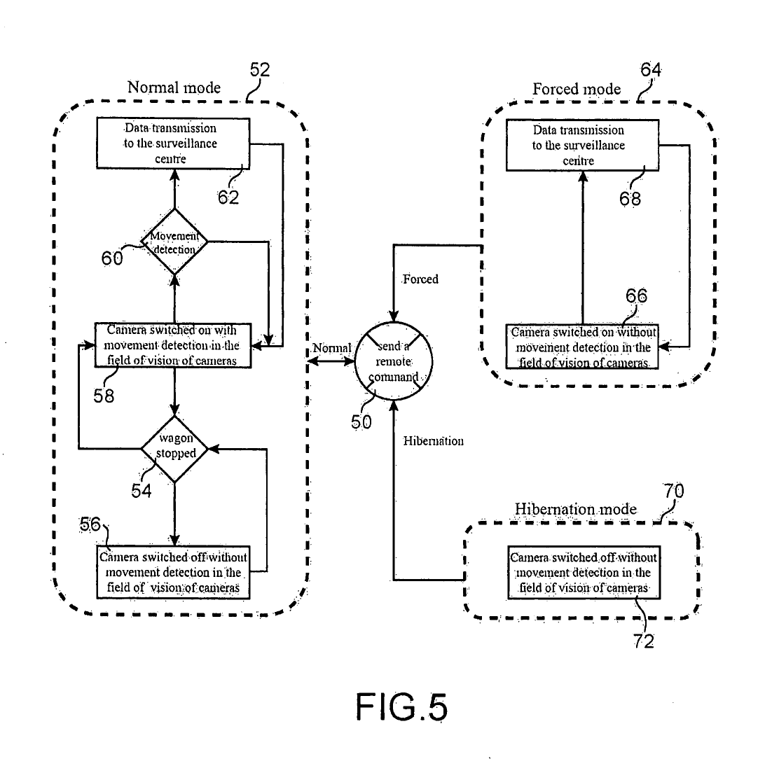

FIG. 5 is a flowchart of the system according to the invention.

On FIGS. 1 and 2, the general reference 2 denotes a wagon transporting a load 4 that has to protected by means of the onboard surveillance device according to the invention. In this example, two cameras are used for surveillance of the surroundings of the wagon. The wagon is provided with a mast 6 at two of its diagonally opposite ends, for this purpose. One camera head 8 is arranged at the end of each of the two masts 6. As can be seen particularly clearly on FIG. 2, each of the camera 8 heads covers a field 10 that contains the entire load 4 and the surroundings of this load. The two cameras face each other. The camera at the left on FIG. 2 is used for surveillance of one end of the wagon and the other camera at the right on the figure is used for surveillance of the other end of the same wagon. Thus, anyone approaching the wagon will be detected and recorded even if he is behind a camera and it will be impossible for a badly intentioned person to approach the wagon without entering the field of vision of the cameras. However, it would be possible to provide more cameras, for example four cameras with one on each corner of the wagon.

Reference 12 denotes an electronic box to which the two camera heads 8 are connected.

FIG. 3 shows a diagram of the electronic box 12. It contains a server 14 provided with a processor. The server is connected to the camera heads 8 through an analogue-digital converter 16 and a processor 17. There is a single processor for all cameras if there are several cameras, as is the case in this example. Since the processor is located in the box 12 that contains the onboard server 14, only the camera heads are outside the box.

The cameras 8 are capable of operating in very low brightness. They are capable of recording images starting from a brightness equal to 0.0003 Lux. At illumination levels this low, cameras only provide black and white images because there is hardly any light. One or more infrared projectors 47 may be provided, to prevent the images from being difficult to interpret due to back-lighting (see FIG. 4).

The server 14 is connected to an antenna 18, for example a GPRS (General Packet Radio Service) antenna connected to a GPRS modem 20.

The GPRS is a non-vocal value added service that transmits information through a mobile telephony network. Its theoretical maximum speed is 171.2 kbytes per second. GPRS is an easy to use technology that can be installed and maintained with no high level expertise. It can be replaced by the EDGE (Enhanced Data Rates for GSM Evolution) simply by replacing the GPRS modem by an EDGE modem. The EDGE wireless multi-modem can also be used and is compatible with the GPRS and the EDGE technologies.

The GPRS is an open Internet infrastructure. Consequently, it is theoretically vulnerable to pirating. It preferably comprises a firewall, so as to prevent such attacks on the system. This firewall automatically provides a VPN (Virtual Private Network) that encrypts information to assure its confidentiality. It also rejects any connection of users who are not authenticated, and consequently prevents pirates from accessing the system.

The server 14 is also connected to a GPS antenna 22. Its electricity power supply is provided by a battery 24 connected to the server through a voltage converter 26 and a power relay 28. A means of detecting when the wagon is stopped notifies the server 14 about whether the wagon is stopped or is in the moving state. In this example, this means is a vibration detector 30, but it could also be a remote ultrasound detector. A removable storage unit 32 can record data on the server 14. This unit 32 is preferably a flash memory. Thus, there are no moving parts in the electronic box 12. In particular, there is no rotating hard disk.

FIG. 4 shows an overall diagram of the surveillance system according to the invention. The GPRS modem 20 transmits data provided to it by the server 14 on Internet 38, through its antenna 18. These data can then be retrieved, for example using a conventional ADSL modem 40 on a remote station 42. These data may also be archived on a mass storage memory 44. Reference 46 denotes the surveillance centre as a whole.

Once the electronic box 12 is connected to the batteries 24 through the power supply cable, the processor of the server 14, the GPS and the GPRS modem start automatically and record the wagon at the surveillance centre 46. The cameras do not start automatically.

The system can operate in three different modes, namely normal operating mode, hibernation mode and forced operating mode.

In normal operating mode of the surveillance system, the system operates differently depending on whether the wagon is stopped or moving. Therefore, the server continuously samples the vibration detector 30 to determine whether or not the wagon is moving.

When the detector 30 has notified the server that wagon has stopped, the server switches the cameras on and activates the movement detection means surrounding the transport means. In particular, these means may comprise an infrared detector 31, represented in dashed lines. However, in the example described, the movement is detected visually by computer processing done by the image server of images that it receives from cameras. Each camera samples its field of vision at a time interval defined by the operator and that can be half a second. The server compares the images to determine if there has been an important change from one image to the next, which would mean that something or someone has moved within the field of vision. The parameters that determine what should be understood by an important change can be entirely under the control of the operator. When a movement is detected, images are transmitted by the server 14 to the surveillance centre 46 at a time interval defined by the operator.

The images reception at the surveillance centre activates a display software that immediately displays intrusion images in the field of vision of the cameras such that the operator in the surveillance centre has an instantaneous view of the situation in the surroundings of the wagon. The display software may for example be the Quick View® software marketed by the Canberra company.

The header of these images identifies them as an alarm. They are marked with the date and the time, the GPS coordinates of the wagon, the condition of the batteries and the operating mode of the system.

Intrusion images continue to be transmitted at the time interval defined by the operator until there is no longer any change in the image. A number defined by the post-alarm image operator can also be transmitted.

If the communication is lost, an alarm signalling loss of communication will be displayed at the surveillance centre and images that no longer need to be transmitted will be recorded on the removable storage unit 32. Once the communication has been restored, images recorded during the loss of communication will be transmitted to the surveillance centre.

When the wagon 2 starts moving, the detector 30 provides the server with the information that the wagon is moving. The server then switches the cameras off and no images are collected. The server goes into waiting mode. In this mode, it samples the GPS and waits for commands from the surveillance centre.

Apart from the normal operating mode just described, the system may also operate in hibernation mode. The operator in the surveillance centre remotely controls the changeover from one mode to another. When the server receives a command to deactivate itself from the surveillance centre, it immediately switches the cameras off and enters standby mode, regardless of whether the transport means is moving or stopped. This operating mode is attractive when the wagon is in a zone in which there is no concern about possible intrusion. It can increase the endurance of the system by avoiding the need for unnecessary surveillance.

The system remains in the standby state until it receives a new command from the surveillance centre. When the processor receives a command from the surveillance centre to change into normal operating mode, it resumes normal operating mode.

Finally, in a third operating mode, the system can operate in forced mode. In this case too, the operator of the surveillance centre remotely controls the change in the operating mode. In this mode, the server switches the camera on continuously, regardless of whether the transport means is moving or stopped, the server (14) then continuously transmitting data to the surveillance centre through the telecommunication means (18, 20). The system remains in this active state until it receives a new command from the surveillance centre.

FIG. 5 shows a flowchart summarising operation of the surveillance device according to this invention. In step 50, the surveillance centre 46 sends a remote command, so as to select the operating mode of the system (normal, forced or hibernation). In normal operating mode 52, a test is made in step 54 to determine whether or not the wagon is stepped. If it is not, cameras are switched off in step 56, and no movement is detected. On the other hand, if the wagon is stopped, the cameras are switched on and movement may be detected in the field of vision of these cameras, in step 58. In step 60, a test is made to determine whether or not a movement is detected. If no movement is detected, movement detection continues in step 58. If it is, which is the case in step 62, data are transmitted to the surveillance centre 46. Data transmission to the surveillance centre continues as long as movement is detected. When movement is no longer detected, transmission of images to the surveillance centre is terminated.

When the surveillance centre 46 sends a command to start the system in forced mode, the system changes to forced mode 64. In step 66, the cameras are switched on, regardless of whether the wagon is stopped or moving, but movement detection is not activated. In other words, data are transmitted to the surveillance centre in step 68, regardless of whether or not movement is detected. The system remains in forced operating mode until a new command terminates this mode.

When a remote hibernation command is sent to the system, the system changes to hibernation mode 70. In the case, the cameras are switched off without any movement detection, in step 72. The system remains in hibernation mode until a new command changes it to another mode.

1. Surveillance system close to a transport means characterised in that it comprises:
at least one camera (8) onboard the transport means (2), the field of vision (10) of this camera covering the entire surrounds of the transport means;
a means of detecting movement (31) in the surrounds of the transport means;
an onboard server (14) that can hold images of the camera (8) and information from the means of detecting movement close to the transport means;
a telecommunication means (18, 20) to transmit data provided by the server (14) to a surveillance centre (46) at a distance from the transport means;
a means (30) of detecting when the transport means stops,
the server switching the camera on or off and activating or deactivating the means of detecting movement close to the transport means as a function of information that it receives from the means (30) of detecting when the transport means is stopped.

2. Surveillance system according to claim 1, characterised in that in a normal operating mode (52),
the server (14) switches the camera on and activates the means of detecting movement close to the transport means when it receives information from the means of detecting that the transport means is stopped, the server (14) then transmitting data to the surveillance centre (46) through the telecommunication means (18, 20) when a movement has been detected in the surrounds of the transport means,
the server switches the camera off and deactivates the means of detecting movement close to the transport means when it has received information from the means (30) of detecting that the transport means is stopped, informing it that the transport means has started moving.

3. Surveillance system according to claim 1, characterised in that in a hibernation mode (70), the server (14) switches the camera (8) off and deactivates the means of detecting movement close to the transport means, regardless of whether the transport means is moving or stopped.

4. Surveillance system according to claim 1, characterised in that in a forced operating mode (64) the server switches the camera on continuously, regardless of whether the transport means is moving or stopped, the server (14) then transmitting data continuously to the surveillance centre through the telecommunication means (18, 20).

5. Surveillance system according to claim 1, characterised in that the means of detecting movement close to the transport means is composed of either an infrared detector (31), or by the server (14) processing images that it receives from the camera (8) so as to detect a movement in its field of vision.

6. Surveillance system according to claim 1, characterised in that data transmitted through the telecommunication means (18, 20) include images close to the transport means.

7. Surveillance system according to claim 6, characterised in that data transmitted by the telecommunication means (18, 20) comprise data chosen from the group comprising the GPS coordinates of the transport means, the condition of the system power supply batteries (24), timestamping of images, a transport means identification number, a camera identification number, the state of the transport means (stopped or moving), the normal operating mode (system in hibernation or in forced operation) and sounds, in addition to images.

8. Surveillance system according to claim 1, characterised in that the means of detecting that the transport means have stopped are composed either of a vibration detector (30), or a remote ultrasound detector.

9. Surveillance system according to claim 1, characterised in that the means of detecting movement close to the transport means detect movement in the field of vision of the camera.

10. Surveillance system according to claim 1, characterised in that it comprises means (32) of storing images taken by the camera (8).

11. Surveillance system according to claim 1, characterised in that the camera (8) is capable of recording images from a brightness starting from 0.0003 lux.

12. Surveillance system according to claim 11, characterised in that it comprises infrared projectors (47).

13. Surveillance system according to claim 1, characterised in that it comprises two cameras (8) located at diagonally opposite corners of the transport means (2).

14. Surveillance system according to claim 1, characterised in that it comprises four cameras (8) located at the four corners of the transport means (2).

15. Surveillance system according to claim 1, characterised in that each camera comprises a head (8) connected to a processor, a single processor being provided for all cameras if there are several cameras, the processor being arranged in a box (12) that contains the onboard server (14), so that nothing is outside the box except for the camera heads.
